(19) United States
(12) Patent Application Publication
(10) Pub. No.: US 2012/0233937 A1
(43) Pub. Date: Sep. 20, 2012

(54) ANCHORING SYSTEM FOR SWIMMING POOL STAIRS

(75) Inventor: Jacques ST-PIERRE, Sherbrooke (CA)

(73) Assignee: 9189-2356 QUEBEC INC., Victoriaville (CA)

(21) Appl. No.: 13/282,036

(22) Filed: Oct. 26, 2011

Related U.S. Application Data
(63) Continuation of application No. 11/946,681, filed on Nov. 28, 2007, now abandoned.
(60) Provisional application No. 60/867,665, filed on Nov. 29, 2006.

(51) Int. Cl. E04F 11/022; E04F 11/18; F16B 47/00

(52) U.S. Cl. 52/173.1; 248/206.3; 52/182

(57) ABSTRACT

The invention provides a staircase arrangement for use within a swimming pool. The staircase arrangement comprises a staircase and at least one suction device. The staircase includes a set of stairs, a bottom-facing surface and a wall-facing surface. Each of the at least one suction devices comprises an attachment portion for attachment to at least one of the bottom-facing surface and the wall-facing surface of the staircase and a suction portion suitable for establishing a suction connection with an interior surface of the swimming pool so as to secure the staircase to the interior surface of the swimming pool.

### CROSS-REFERENCE TO RELATED APPLICATIONS

This application is a continuation application of U.S. patent application Ser. No. 11/946,681 filed Nov. 28, 2007 which claims the benefit of U.S. provisional application Ser. No. 60/867,665 filed Nov. 29, 2006. The contents of both are incorporated herein by reference.

### FIELD OF THE INVENTION

The present invention relates generally to anchoring systems for swimming pool stairs, and more particularly, to anchoring systems that includes suction devices for securing the swimming pool stairs to the interior of a swimming pool.

### BACKGROUND

Most in-ground swimming pools have one or more sets of stairs for enabling swimmers to enter and exit the swimming pool with ease. These stairs can be either built-in stairs or removable stairs.

Removable stairs come in many different formats, such as ladder-type stairs or staircase-type stairs. Removable stairs can be advantageous since they don't take up as much room as built-in stairs and they can be re-positioned at different locations within the swimming pool. However, in the case of ladder-type stairs, the steps of the ladder are positioned one on top of the other, which users often find difficult to use. More specifically, these ladder-types of stairs require significant coordination since a user is required to enter the pool backwards while at the same time maintaining a grip on a hand railing.

Removable stairs of the staircase-type are more natural to use since a user can just walk down the steps in the same way as they would with any other type of staircase. However, removable stairs of this type also have deficiencies. Firstly, these types of staircases are typically made of hollow shells and, as such, need to be filled with sand or another type of ballast in order to keep them anchored on the bottom of the swimming pool floor. These ballast materials are generally quite expensive, thereby adding to the cost of the staircase. It is also very messy to fill and unfill the staircase, since the ballast material is dirty and difficult to install. Secondly, by simply using ballast to weigh down the staircase, the staircase is not necessarily securely installed at a desired location within the swimming pool. Instead, the staircase can move around, and in certain circumstance scratch or otherwise damage the lining or tiles within the swimming pool. Finally, due to the weight of the ballast within the staircase, the staircase is difficult to move and maneuver when installing it within the swimming pool or removing it from the swimming pool.

In light of the above, it can be seen that there remains a need in the industry to for an anchoring system for removable swimming pool staircases that alleviates at least in part the deficiencies with existing stairs.

### SUMMARY OF THE INVENTION

In accordance with a first broad aspect, the invention provides a staircase arrangement for use within a swimming pool. The staircase arrangement comprises a staircase and at least one suction device. The staircase includes at least two steps, a bottom-facing surface and a wall-facing surface. Each of the at least one suction devices comprises an attachment portion for attachment to at least one of the bottom-facing surface and the wall-facing surface of the staircase and a suction portion suitable for establishing a suction connection with an interior surface of the swimming pool so as to secure the staircase to the interior surface of the swimming pool.

In accordance with a second broad aspect, the invention provides a removable staircase for use within a swimming pool. The removable staircase comprises a hollow body portion that comprises a bottom-facing surface suitable for being positioned against a bottom floor of the swimming pool, a wall-facing surface suitable for being positioned against an interior wall portion of the swimming pool, at least two steps and at least one aperture. The at least one aperture is located within at least one of the bottom-facing surface and the wall-facing surface. The at least one aperture is operative for securely holding an attachment portion of a suction device.

In accordance with a third broad aspect, the invention provides an anchoring system for a set of swimming pool stairs. The swimming pool stairs have a bottom-facing surface and a wall-facing surface. The anchoring system comprises at least one suction device that comprises an attachment portion for attachment to at least one of the bottom-facing surface and the wall-facing surface of the set of stairs and a suction portion suitable for establishing a suction connection with an interior surface of the swimming pool so as to secure the set of stairs to the interior surface of the swimming pool.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a front perspective view of a staircase arrangement in accordance with a non-limiting example of implementation of the present invention;

FIG. 2 illustrates a bottom perspective view of the staircase arrangement of FIG. 1;

FIG. 3 illustrates a bottom plan view of the staircase arrangement of FIG. 1;

FIG. 4 illustrates a side plan view of the staircase arrangement of FIG. 1;

FIG. 5 illustrates a back plan view of the staircase arrangement of FIG. 1;

FIG. 7 illustrates a perspective representation of the staircase arrangement of FIG. 1 positioned within a swimming pool;

FIG. 8 illustrates a top perspective view of a suction device in accordance with a non-limiting example of implementation of the present invention;

FIG. 9 illustrates a side plan view of the suction device of FIG. 8;

FIG. 10 illustrates a bottom plan view of the suction device of FIG. 9;

FIG. 11 illustrates a cross-sectional view of the staircase shown in FIG. 1; and

FIG. 12 illustrates an exploded cross-sectional view of the suction device of FIG. 8 attached to the staircase of FIG. 1.

It is to be expressly understood that the description and drawings are only for the purpose of illustration of certain embodiments of the invention and are an aid for understanding. They are not intended to be a definition of the limits of the invention.

### DETAILED DESCRIPTION

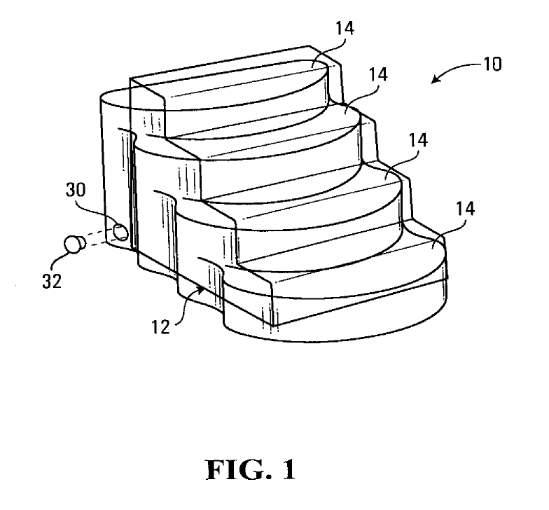

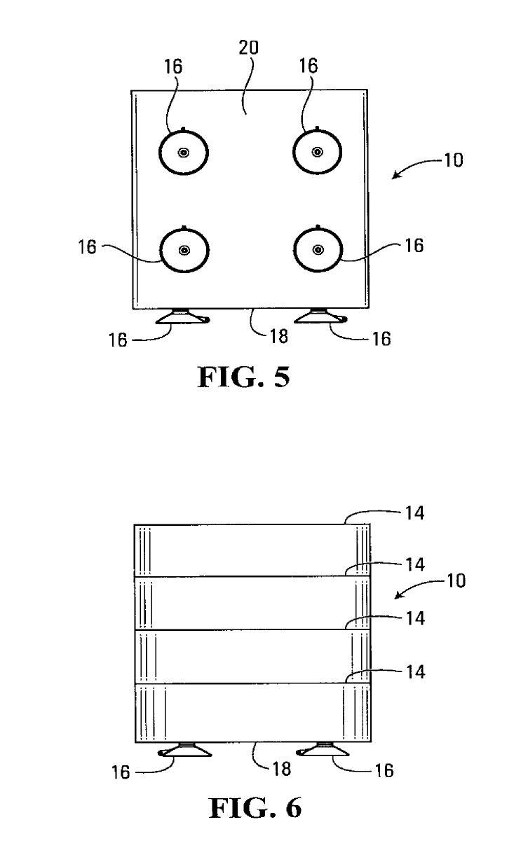

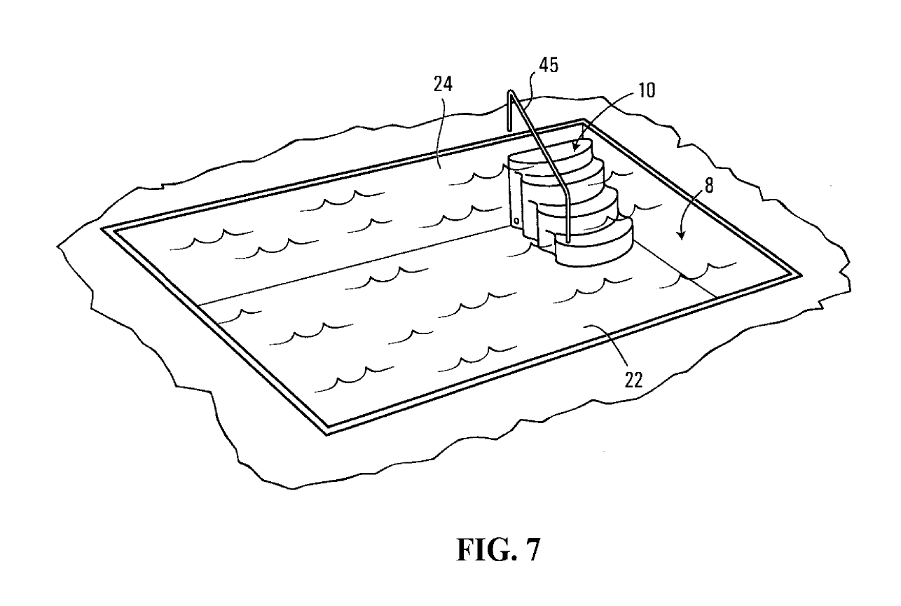

Shown in FIGS. 1 through 6 is a removable swimming pool staircase arrangement 10 in accordance with a non-limiting example of implementation of the present invention As shown, the staircase arrangement 10 includes a staircase 12 and a plurality of suction devices 16 for securing the staircase 12 to the interior surface of a swimming pool (as shown in FIG. 7).

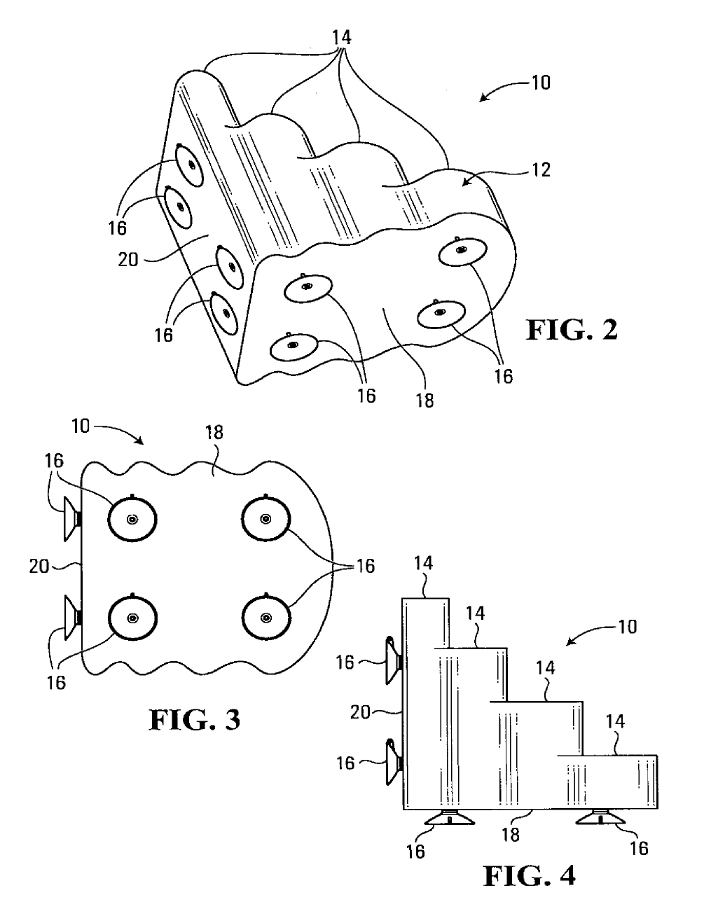

As best shown in FIG. 2, the staircase 12 comprises a plurality of steps 14, a bottom-facing surface 18 and a wall-facing surface 20. In the embodiment shown, the staircase 12 includes four steps 14. However, it should be appreciated that a staircase 12 having any number of steps is included within the scope of the present invention. The number of steps 14 can vary depending on the intended use of the staircase 12. For example, the number of steps 14 can vary depending on the depth of the swimming pool and the desired distance between steps, among other factors.

The staircase 12 can be made of a variety of different materials such as plastic, fiberglass and/or a composite material. In accordance with a non-limiting embodiment, the staircase 12 is made of a plastic material that is molded into a hollow shell having the desired shape. As such, the staircase 12 includes an interior cavity within the hollow shell. As shown in FIG. 1, an opening 30 is included within the staircase 12 for accessing the interior cavity. The opening 30 can be sealed with a closure device 32, such as a plug or cap. The closure device 32 may seal the opening 30 via a pressure fit, a snap fit, or via threaded engagement, among other possibilities. Although the opening 30 is shown in FIG. 1 as being on the side of the staircase 12, it should be appreciated that the opening 30 could be located on any surface of the staircase 12, including the bottom-facing surface 18 and/or the wall-facing surface 20. The size of the opening 30 can vary.

As mentioned above, the staircase arrangement 10 includes a plurality of suction devices 16. In the embodiment shown, the suction devices 16 are divided into a first set of suction devices that are attached to the bottom-facing surface 18 of the staircase 12 and a second set of suction devices that are attached to the wall-facing surface 20 of the staircase 12. Although FIGS. 2-6 show suction devices 16 included on both the bottom facing surface 18 and the wall-facing surface 20 of the staircase 12, it should be appreciated that in an alternative embodiment, suction devices 16 may be included on only one of the bottom-facing surface 18 or the wall-facing surface 20. For example, suction devices 16 may be included only on the bottom-facing surface 18 of the staircase 12. Or, suction devices 16 may be included only on the wall-facing surface 20 of the staircase 12.

In the embodiment shown, four suction devices 16 are included on the bottom-facing surface 18 and four suction devices 16 are included on the wall-facing surface 20. It should, however, be appreciated that more or less suction devices 16 can be included on each of the bottom-facing surface 18 and/or the wall-facing surface 20 without departing from the spirit of the invention. For example, anywhere between one suction device 16 and twenty (or more) suction devices 16 can be included on each of the bottom-facing surface 18 and the wall-facing surface 20 of the staircase 12. In addition, the same number of suction devices 16 can be included on the bottom-facing surface 18 as the wall-facing surface 20, or alternatively, a different number of suction devices 16 can be included on the respective surfaces. For example, the bottom-facing surface 18 may include four suction devices 16, while the wall-facing surface 20 may include only two suction devices 16. As such, it should be appreciated that any number and configuration of suction devices 16 can be included on the bottom-facing surface 18 and the wall-facing surface 20 of the staircase.

Likewise, the manner in which the suction devices 16 are arranged on the bottom-facing surface 18 and/or the wall-facing surface 20 of the staircase 12 can vary, without departing from the spirit of the invention. In accordance with a first example, the suction devices 16 are arranged on the bottom-facing surface 18 and/or the wall-facing surface 20 in accordance with a pattern, such as in a square-shaped configuration, as shown in FIGS. 2, 3 and 5. In such an embodiment, the suction devices 16 are typically evenly distributed on the bottom-facing surface 18 and/or the wall-facing surface 20 of the staircase 12 so as to secure the staircase 12 to an interior surface of a swimming pool in a uniform manner. Alternatively, the suction devices 16 can be distributed in accordance with a random, or un-even configuration. The best, or most desirable, manner in which the suction devices 16 are arranged on the staircase 12 can be determined by a manufacturer of the staircase arrangement 10.

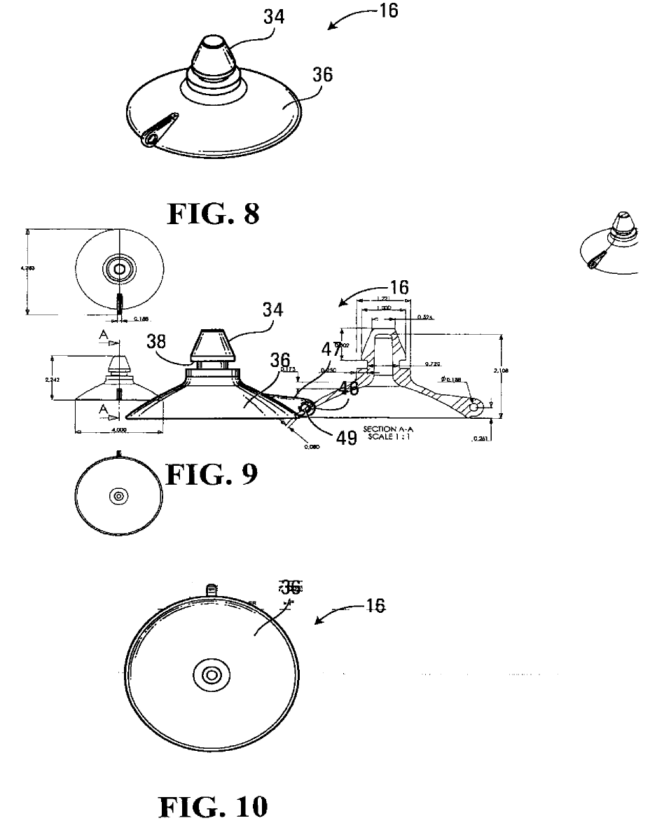

Shown in FIGS. 8 and 9 is an example of a suction device 16 in accordance with a non-limiting example of implementation of the present invention. As shown, each suction device 16 includes an attachment portion 34 for attaching the suction device 16 to the staircase 12, and a suction portion 36 for enabling the suction device 16 to establish a suction connection with an interior surface of the swimming pool. In the embodiment shown in the Figures, the attachment portion 34 is in the shape of an inverted truncated cone that has a flat abutment surface 38 at its base.

As shown in FIG. 10, the suction portion 36 of the suction device 16 is in the shape of a concave circular disk. When a downward force is exerted on the suction device 16, the circular disk moves downwardly and splays outwardly. This pushes the air out from between the concave disk and the surface to which it is being applied, thus creating a vacuum between the suction device 16 and the given surface. This vacuum seals the suction portion 36 to the surface to which it is applied, thus creating a suction connection between the surface and the suction device 16.

Each of the suction devices 16 includes a release-facilitating portion 46 such that once a suction connection has been established between the suction device 16 and a surface, the suction connection can be broken, such that the suction device can be removed from the surface. In the non-limiting embodiment shown, the release-facilitating portion 46 includes a flange portion 47, with a hole 49 positioned therethrough. In this manner, by grabbing the flange portion 47 and lifting upwardly, air is able to enter underneath the suction portion 36 of the suction device 16, thus breaking the vacuum seal.

In accordance with a non-limiting embodiment, the suction portion 36 of the suction device 16 has a diameter of between 2.5 and 5 inches. It should however be appreciated that a suction device 16 having any diameter is included within the scope of the present invention.

The suction devices 16 can be made from a variety of different materials. For example, the suction devices 16 can be made from natural rubber or synthetic rubber such as polyvinylchloride (PVC plastic) and/or neoprene. However, any material, whether natural or synthetic, that provides appropriate flexibility, elasticity, durability and strength can be used to make the suction devices 16.

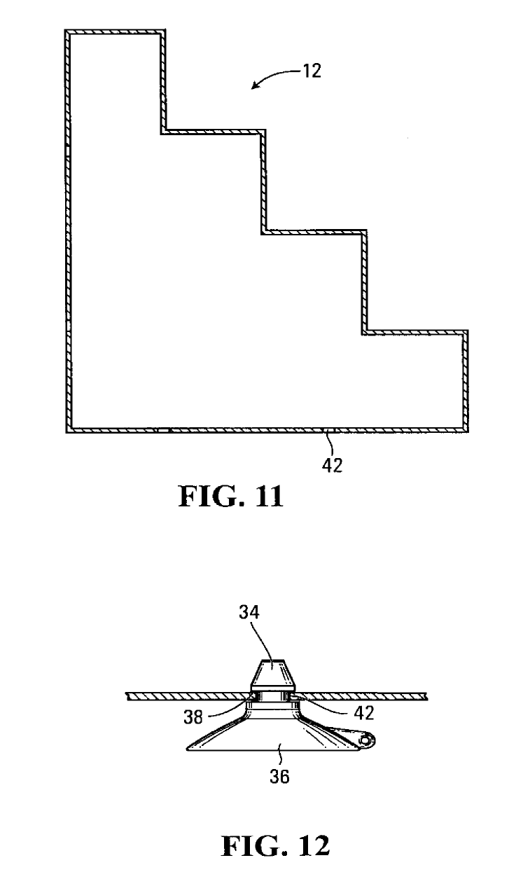

As shown in FIG. 11, the staircase 12 includes a plurality of apertures 42 for enabling the suction devices 16 to be attached to the staircase 12. The number of apertures 42 included within the staircase 12 is dependent on the intended number of suction devices 16 that are to be attached to the staircase 12. In general, the staircase 12 includes one aperture 42 per suction device 16 that is to be attached thereto.

In order to receive the four suction devices 16 on the bottom facing surface 18, and four suction devices 16 on the wall-facing surface 16, the staircase 12 shown in the Figures includes four apertures 42 on the bottom facing surface 18 and four apertures 42 on the wall facing surface 20.

As shown in FIG. 11, each aperture 42 includes an opening that extends into the hollow cavity of the staircase 12. The apertures 42 are wide enough to receive the truncated cone-shaped attachment portion 34 of the suction device 16, such that when the attachment portion 34 is pushed into the aperture 42, the opening expands and the attachment portion 34 eventually snaps into the cavity of the staircase 12. In this manner, the flat abutment surface 38 of the attachment portion 34 abuts against the interior wall of the housing of the staircase 12. As such, once the attachment portion 34 of the suction device 16 has been inserted into the aperture 42 via this snap-fit arrangement, the suction device 16 cannot be easily removed from the staircase 12.

In alternative embodiments, the suction devices 16 can be attached to the staircase in other ways. For example, the attachment portion 34 may include threads, such that the suction device 16 is secured to the staircase 12 by threading the attachment portion 34 into corresponding threads within a recess in the staircase 12. In yet another alternative, the suction device 16 can be attached to the staircase via adhesive or mechanical fasteners. In yet a further alternative embodiment, the suction devices 16 can be an integrally molded part of the staircase 12.

The manner in which the removable staircase arrangement 10 is installed within a swimming pool will now be described in more detail. Firstly, the suction devices 16 are attached to the staircase 12 and a small amount of ballast material, is inserted within the hollow cavity of the staircase 12 through the opening 30. This ballast material can be sand, gravel, silica granules, or any other known ballast material, which helps to add weight to the hollow staircase structure. Once the ballast material has been inserted within the hollow cavity of the staircase 12, the closure device 32 seals the cavity such that the ballast is trapped within the cavity. In an alternative embodiment, the ballast can be inserted within the cavity prior to the suction devices 16 being attached to the staircase 12. These two steps are interchangeable.

As shown in FIG. 7, the staircase arrangement 10 is then positioned within the interior of a swimming pool 8. Once the staircase arrangement 10 has been positioned at a desired location within the swimming pool 8, a downward force is then applied to the staircase 12, such that the suction devices 16 located on the bottom-facing surface 18 of the staircase 12 establish a suction connection with the bottom surface 22 of the swimming pool 8. Likewise, a lateral force is applied to the staircase 12 in the direction of an interior wall 24 of the swimming pool 8, such that the suction devices 16 located on the wall-facing surface 20 of the staircase 12 establish a suction connection with the side wall 24 of the swimming pool 8. Once the suction devices 16 have established a suction connection with these interior surfaces of the swimming pool 8, the staircase arrangement 10 is secured to the interior surface of the swimming pool via the suction connections established by the suction devices 12. It should be appreciated that the downward force and the lateral side-force can be applied to the staircase simultaneously, or in a sequential manner. In addition, these forces can be applied to the staircase arrangement 10 manually, or using equipment or machinery.

The suction devices 16 that are used to secure the removable staircase 12 to the interior surface of the swimming pool 8 are able to maintain the staircase 12 in place more securely and effectively than traditional anchoring systems that simply relied on the weight of the ballast material to keep the staircase in place. While some ballast is still used in combination with the suction devices 16, the use of the suction devices 16 allows less ballast to be used. Traditionally, removable staircases have required between 200-300 lbs of ballast in order to maintain the staircases in place within the swimming pool. However, by using the suction devices 16 in combination with the ballast, the ballast can be reduced to approximately 50 lbs. This means that less of the costly ballast material is required, and makes the staircase arrangement 10 of the present invention easier to manipulate and position within the interior of the swimming pool than traditional removable staircases. The weight reduction, and minimization of ballast material also make the staircase arrangement 12 easier to remove from the swimming pool in the case where the staircase 12 needs to be cleaned or repaired.

Finally, the staircase arrangement 10 of the present invention creates less damage to the liner and/or tiles of the swimming pool than more traditional types of removable staircases that are filled with hundreds of pounds of ballast material. This is due in part to the fact that the staircase arrangement 10 is significantly lighter than traditional staircase arrangements since it does not contain as much ballast. However, it is also due in part to the fact that the suction devices 16 provide a cushioning surface on which the staircase 12 rests within the swimming pool. In addition, the suction devices 16 reduce the amount of surface-to-surface contact between the bottom-facing surface 18 of the staircase 12, and the bottom surface 22 of the swimming pool.

Referring back to FIG. 7, in certain circumstances the staircase arrangement 10 includes a hand railing 45. The hand railing 45 generally extends between a surface located outside of the swimming pool and a location on the bottom portion of the stair case 12. In this manner, a user is able to hold onto the hand railing 45 as he or she walks down the steps. The hand railing 45 can fit into a slot within the staircase 12, or alternatively can be bolted or riveted to the staircase. Manners of attaching hand railings to swimming pool staircases are known in the art, and as such will not be described in more detail herein.

In accordance with a first non-limiting example of implementation of the present invention, the staircase 12 and the suction devices 16 described herein are sold separately. However, in an alternative embodiment, the staircase 12 and a suitable number of suction devices 16 are packaged together, such that they are sold as a kit. In this manner, a customer simply needs to purchase one kit in order to have all the components needed to install the removable staircase arrangement 10 within a swimming pool. In certain circumstances, the hand railing 45 is also included within the kit.

While specific embodiments of the present invention have been described and illustrated, it will be apparent to those skilled in the art that further modifications and variations can be made without departing from the scope of the invention as defined in the appended claims.

1. A staircase for use within a swimming pool, comprising:
a staircase including at least two steps, a bottom-facing surface and a wall-facing surface;
said bottom facing surface having a curved edge and wavy side edges and said wall facing surface having straight edges; and
a plurality of suction devices, each suction device
wherein said plurality of suction devices are divided into a first set of suction devices and a second set of suction devices, said attachment portions of said first set of suction devices being attached to said bottom-facing surface of said staircase, and said attachment portions of said second set of suction devices being attached to said wall-facing surface of said staircase, and said first and second sets of suction devices being arranged in substantially identical patterns at said bottom-facing surface and said wall-facing surface, respectively.

2. A staircase arrangement as defined in claim 1, wherein
said first set of suction devices includes at least four suction devices and said second set of suction devices includes at least four suction devices.

3. A staircase arrangement as defined in claim 1, wherein
each suction device in said plurality of suction devices includes a release-facilitating portion, said release facilitating portion being operative for breaking the suction connection between the suction device and an interior surface of the swimming pool.

4. A staircase arrangement as defined in claim 3, wherein
said release-facilitating portion includes a flange portion with a hole therethrough.

5. A staircase arrangement as defined in claim 4, further comprising
a hand railing portion for extending from the staircase to a surface that is outside the swimming pool.

6. A staircase arrangement as defined in claim 1, wherein
said attachment portion of each of said plurality of suction devices is attached to the at least one of said bottom-facing surface and said wall-facing surface of said staircase via a snap-fit arrangement.

7. A staircase arrangement as defined in claim 1, wherein
said suction portion of each of said plurality of suction devices includes a concave cup-shaped disc, said concave cup-shaped disc having a diameter of between 2.5 to 5 inches.

8. A staircase arrangement as defined in claim 1, wherein
said staircase is formed from a plastic material.

9. A staircase arrangement as defined in claim 8, wherein
said staircase is formed from a hollow shell.

10. A staircase arrangement as defined in claim 9, wherein
said hollow shell includes a sealable opening for receiving ballast.
